(19) United States
(12) Patent Application Publication
(10) Pub. No.: US 2025/0158187 A1
(43) Pub. Date: May 15, 2025

(54) PRISMATIC BATTERY ASSEMBLIES CONTAINING LONG CELLS WITH INTERLEAVED GAS MANIFOLDS AND ELECTRIC BUSBARS

(71) Applicant: GM GLOBAL TECHNOLOGY OPERATIONS LLC, Detroit, MI (US)

(72) Inventors: Diptak Bhattacharya, Royal Oak, MI (US); Derek F. Lahr, Howell, MI (US); Xiaoling Chen, Sterling Heights, MI (US); Anil K. Sachdev, Rochester Hills, MI (US); Thomas A. Barth, Macomb Township, MI (US); Christopher P. Scolaro, Rochester, MI (US); Andrew C. Bobel, Troy, MI (US); Ryan P. Hickey, Austin, TX (US)

(73) Assignee: GM GLOBAL TECHNOLOGY OPERATIONS LLC, Detroit, MI (US)

(21) Appl. No.: 18/508,877

(22) Filed: Nov. 14, 2023

(51) Int. Cl. H01M 50/209; H01M 10/613; H01M 10/647; H01M 10/6554; H01M 50/249; H01M 50/358; H01M 50/507

(52) U.S. Cl. CPC H01M 50/209; H01M 10/613; H01M 10/647; H01M 10/6554; H01M 50/249; H01M 50/358; H01M 50/507

(57) ABSTRACT

Presented are battery assemblies containing long prismatic cells with interleaved gas manifolds and electrical busbars, methods for making/using such battery assemblies, and vehicles equipped with such battery assemblies. A prismatic battery assembly includes multiple stacks of prismatic battery cells that are located inside of and extend longitudinally across a rigid and insulated assembly housing. Each battery cell includes a prism-shaped cell can that contains one or more electrochemical cells. Located at one or both lateral ends of each cell can are a cell vent and a pair of electrical terminals. Electrically connected to the battery cell terminals is an electrical busbar that is located inside the assembly housing, either between the cell stacks or laterally outboard of the cell stacks. Fluidly connected to the battery cell vents is a gas manifold that is located inside the assembly housing, either between the cell stacks or laterally outboard of the cell stacks.

### INTRODUCTION

The present disclosure relates generally to electrochemical devices. More specifically, aspects of this disclosure relate to traction battery packs with passive thermal management systems for regulating the operating temperatures of prismatic battery cells.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability, relative light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

A full-electric vehicle (FEV)—colloquially labeled an “electric car”—is a type of electric-drive vehicle configuration that altogether omits an internal combustion engine and attendant peripheral components from the powertrain system, relying instead on a rechargeable energy storage system (RESS) and a traction motor for vehicle propulsion. The engine assembly, fuel supply system, and exhaust system of an ICE-based vehicle are replaced with a single or multiple traction motors, rechargeable battery cells, and battery cooling and charging hardware in a battery-based FEV. Hybrid-electric vehicle (HEV) powertrains, in contrast, employ multiple sources of tractive power to propel the vehicle, most commonly operating an internal combustion engine assembly in conjunction with a battery-powered or fuel-cell-powered traction motor. Since hybrid-type, electric-drive vehicles are able to derive their power from sources other than the engine, HEV engines may be turned off, in whole or in part, while the vehicle is propelled by the electric motor(s).

### SUMMARY

High-voltage (HV) electrical systems govern the transfer of electricity between the traction motors and the rechargeable battery packs that supply the requisite power for operating many hybrid-electric and full-electric powertrains. To provide the power capacity and energy density needed to propel a vehicle at desired speeds for desired ranges, contemporary traction battery packs group multiple battery cells (e.g., 8-16+ cells/stack) into individual battery modules (e.g., 10-40+ modules/pack) that are electrically interconnected in series or parallel and mounted onto the vehicle chassis, e.g., by a battery pack housing or support tray. Located on a battery side of the HV electric system is a front-end DC-to-DC power converter that is electrically connected to the traction battery pack(s) in order to increase the supply of voltage to a main DC bus and a DC-to-AC power inverter module (PIM). A high-frequency bulk capacitor may be arranged across the positive and negative rails of the main DC bus to provide electrical stability and store supplemental electrical energy. A dedicated Electronic Battery Control Module (EBCM), through collaborative operation with a Powertrain Control Module (PCM) and each motor's power electronics package, governs operation of the battery pack(s) and traction motor(s).

The individual cells of a battery pack may generate a significant amount of heat during the pack's charge and discharge cycles. This cell-borne heat is produced primarily by exothermic chemical reactions and losses due to activation energy, chemical transport, and resistance to ionic migration. Within lithium-ion batteries, a series of exothermic and gas-generating reactions may take place as cell temperatures rise that may push the battery assembly towards an unstable state. Such thermal events, if left unchecked, may lead to a more accelerated heat-generating state called “thermal runaway”, a condition in which the battery system is unable to return the internal battery components to normal operating temperatures. An integrated battery cooling system may be employed to prevent these undesirable overheating conditions within such battery packs. Active thermal management (ATM) systems, for example, employ an electronic control module to regulate operation of a cooling circuit that circulates coolant fluid through the heat-producing battery components. For direct liquid cooling (DLC) systems, a heat-transfer coolant may be pumped through a network of internal channels, plates, and pipes within the battery case to thermally conduct heat from the battery cells.

Presented herein are rechargeable battery assemblies containing long prismatic cells with interleaved gas manifolds and electric busbars, methods for making and methods for using such battery assemblies, and vehicles equipped with such battery assemblies. By way of non-limiting example, a traction battery pack solution offers increased volumetric efficiencies by utilizing long prismatic cells (e.g., at least 400-650 mm long) that are stacked face-to-face and arranged in fore-aft rows, with the cell stack rows juxtaposed side-by-side in a cross-car direction. Each battery cell includes a rectangular-prism shaped can with electrical terminals located on one lateral end of the can and a gas vent located on the opposite lateral end. The stacked cells may be sandwiched between and passively cooled by top and bottom cold plates. A thermal runaway (TR) gas manifold may be located between neighboring rows of stacked cells, e.g., extending longitudinally down the center of the pack, and a pair of (port and starboard side) busbars may each extend longitudinally along a respective outboard side of the pack. Alternatively, a pair of (positive and negative) electrical busbars may be located between neighboring rows of stacked cell, e.g., extending longitudinally down the center of the pack, and a pair of (port and starboard side) gas manifolds may each extend longitudinally along a respective outboard side of the pack. The length of the prismatic cells (i.e., long-edge dimension on major face of rectangular polyhedron) extends in the cross-car direction with cell terminals on one short side of the cell (i.e., first minor face) and vents on the other short side (i.e., second minor face). The manifold channels may be integrated into the load-bearing battery pack frame (“halo”) to achieve additional packaging space savings and increased heat dissipation characteristics.

Attendant benefits for at least some of the disclosed concepts include prismatic battery assembly architectures using long cells with interleaved gas manifolds and electric busbars that provide increased volumetric efficiency and reduced TR manifold sizes. Improved thermal management may also be achieved by employing multiple cold plates to extract thermal energy from the cells during operation of the battery pack. Packaging the TR vent(s) and busbar(s) at discrete locations within the battery pack housing may also help to prevent cell gases from causing an electric arcing discharge during a TR event. In addition to optimized packaging and improved gas venting performance, thermal management is improved with a concomitant increase in battery capacity, which leads to improvements in vehicle efficiency and increased driving range.

Aspects of this disclosure are directed to battery assemblies that contain long prismatic cells with interleaved gas manifolds and electrical busbars. In an example, a prismatic battery assembly, such as a rechargeable battery pack or module, includes a protective and insulated assembly housing and multiple prismatic battery cells arranged in cell stacks that are located inside of and extend longitudinally across the assembly housing. Each prismatic battery cell includes a prism-shaped cell can that contains one or more electrochemical cells. The cell can has a cell vent and a pair of electrical terminals that are located at one or both lateral ends of the cell can. Electrically connected to the battery cell terminals is an electrical busbar (positive and negative bus rails) that is located inside the assembly housing, either sandwiched between the cell stacks or mounted laterally outboard of the cell stacks. Fluidly connected to the battery cell vents is a gas manifold that is located inside the assembly housing, either interposed between the cell stacks or positioned laterally outboard of the cell stacks. Any of the herein described battery assembly configurations may be implemented for automotive and non-automotive applications alike.

Additional aspects of this disclosure are directed to motor vehicles with traction battery packs containing fore-aft stacks of long prismatic cells interleaved with in-pack electrical busbars and integrated cell vent manifolds. As used herein, the terms “vehicle” and “motor vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles, motorcycles, farm equipment, watercraft, aircraft, e-bikes, etc. For non-automotive applications, disclosed concepts may be implemented for any logically relevant use, including stand-alone power stations and portable power packs, photovoltaic systems, pumping equipment, wind turbine farms, machine tools, server systems, etc. While not per se limited, disclosed concepts may be particularly advantageous for use with lithium-class (LiFePO₄) secondary prismatic battery cells.

In an example, a motor vehicle includes a vehicle body with a passenger compartment, multiple road wheels mounted to the vehicle body (e.g., via corner modules coupled to a unibody or body-on-frame chassis), and other standard original equipment. For electric-drive vehicle applications, one or more electric traction motors operate alone (e.g., for FEV powertrains) or in conjunction with an internal combustion engine assembly (e.g., for HEV powertrains) to selectively drive one or more of the road wheels to propel the vehicle. A rechargeable traction battery pack is mounted onto the vehicle body, e.g., via a battery pack support tray, and is operable to power the traction motor(s). In addition to the pack and motor, the vehicle may include an active thermal management (ATM) system, a vehicle battery charging (VBC) system, and any attendant peripheral hardware.

Continuing with the preceding discussion, the vehicle's traction battery pack includes a rigid polymeric pack housing with a rectangular array of prismatic battery cells, which is arranged in mutually parallel cell stacks located inside of and extending longitudinally across the pack housing. Each prismatic battery cell includes a rectangular prism-shaped cell can that is fabricated from a rigid metal and/or plastic-coated metal and contains one or more electrochemical cells. The cell can has a cell vent and a pair of electrical terminals that are located at one or both lateral ends of the cell can. These electrical terminals are electrically connected to the cell's internal electrochemical cells, and the cell vent evacuates cell-borne gases from the cell can. The battery cells are long in that a ratio of a length to a height of the opposing major faces of each rectangular prism-shaped cell can is at least about 2:1 or at least about 2.5:1. One or more in-pack electrical busbars is/are electrically connected to the battery cell terminals and located inside the pack housing, either between the cell stacks or laterally outboard of the cell stacks. In addition, one or more in-pack gas manifolds is/are fluidly connected to the prismatic battery cell vents and located inside the pack housing, either between the cell stacks or laterally outboard of the cell stacks.

Aspects of this disclosure are also directed to manufacturing workflow processes, computer-readable media, and control logic for making or for using any of the disclosed prismatic battery cells, battery assemblies, and/or motor vehicles. In an example, a method is presented for constructing a prismatic battery assembly. This representative method includes, in any order and in any combination with any of the above and below disclosed options and features: receiving an assembly housing of the prismatic battery assembly; arranging a plurality of prismatic battery cells in first and second cell stacks; locating the first and second cell stacks inside of and extending longitudinally across the assembly housing, each of the prismatic battery cells including a prism-shaped cell can containing an electrochemical cell, the cell can having a cell vent and a pair of electrical terminals located at first and/or second lateral ends of the cell can; locating an electrical busbar inside the assembly housing between the first and second cell stacks or laterally outboard of the first and second cell stacks; electrically connecting the electrical busbar to the electrical terminals of the prismatic battery cells; locating a gas manifold inside the assembly housing between the first and second cell stacks or laterally outboard of the first and second cell stacks; and fluidly connecting the gas manifold to the cell vents of the prismatic battery cells.

For any of the disclosed vehicles, methods, and battery assemblies, the cell stacks may be arranged substantially parallel to each other with the electrical busbar(s) and gas manifold(s) arranged substantially parallel to each other and to the cell stacks. The assembly housing may include a rigid “halo” frame, e.g., that partially or fully surrounds the prismatic battery cells and includes elongated tubes that are located adjacent the lateral sides of the cell stacks. In this instance, the gas manifold may include two discrete manifolds, each of which extends into and through a respective one of the halo's rigid tubes. As another option, the prismatic battery assembly may include a top cold plate that extends across and extracts thermal energy from a topside of the cell stacks, and a bottom cold plate that extends across and extracts thermal energy from a bottom side of the cell stacks. While most conventional prismatic battery packs are limited to a single cold plate due to a top-mounted electrical interconnect board (ICB) assembly, disclosed prismatic battery assembly solutions enable top and bottom mounted cold plates by repackaging the busbars and gas manifolds on the centerline and/or lateral sides of the stacked battery cells. The assembly housing may also include multiple housing vents that are fluidly connected to the gas manifold; these housing vents receive cell-generated gases from the gas manifolds and evacuate the received gases out from the assembly housing.

For any of the disclosed vehicles, methods, and battery assemblies, each cell can may have a rectangular-prism shape with two opposing major faces, two opposing medial faces substantially orthogonal to and adjoining the major faces, and two opposing minor faces substantially orthogonal to and adjoining the medial faces. The prismatic battery cells may be considered “long” in that a ratio of a cross-car length to a vertical height of the major faces is at least about 2:1 or, in some designs, at least about 2.5:1 or, in some desired solutions, approximately 3.1:1. To this end, a ratio of a fore-aft width of the minor faces to the cross-car length of the major faces may be at least about 3:1 or, in some designs, at least about 4:1 or, in some desired solutions, approximately 5.2:1. When packaged inside the cell can, the major faces of the cell cans may be arranged substantially orthogonal to a longitudinal centerline of the assembly housing and elongated in a cross-car direction. As another option, each cell can may include a first minor face at the first end of the cell can and a second minor face located at the second end of the cell can; the cell vent may extend through the first minor face of the cell can and the electrical terminals may be located on the second minor face of the cell can.

For any of the disclosed vehicles, methods, and battery assemblies, the gas manifold may be located between the cell stacks, extending along a longitudinal centerline of the assembly housing. In this instance, the prismatic battery assembly may include two electrical busbars, each of which is located on respective lateral side of the cell stacks. Alternatively, the electrical busbar may be located between the cell stacks, extending along the longitudinal centerline of the assembly housing. In this instance, the prismatic battery assembly may include two gas manifolds, each of which is located on a respective lateral side of the cell stacks. As another option, both the electrical busbar and the gas manifold may be interposed between the cell stacks and extend along a longitudinal centerline of the assembly housing. Alternatively, the prismatic battery assembly may include multiple electrical busbars, each located on a respective lateral side of the cell stacks, and multiple gas manifolds, each located on a respective lateral side of the cell stacks. It is also envisioned that one gas manifold and one busbar may be packaged between the cell stacks and extend along the longitudinal centerline of the assembly housing, and another gas manifold and another busbar may be packaged on a lateral side of the cell stacks.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle that is propelled by an electrified powertrain and powered by a traction battery pack with which aspects of this disclosure may be practiced.

FIG. 2 is a schematic illustration of a representative electrochemical device with which aspects of the present disclosure may be practiced.

FIG. 3 is a front perspective-view illustration of a representative battery assembly containing multiple rectangular arrays of long prismatic battery cells interleaved with TR gas manifolds and electric busbars in accord with aspects of the present disclosure.

FIG. 4 is a plan-view illustration of a representative battery assembly containing a rectangular array of long prismatic battery cells with a TR gas manifold on a centerline of the assembly and electric busbars on outboard sides of the cell stacks in accord with aspects of the present disclosure.

FIG. 5 is a plan-view illustration of a representative battery assembly containing a rectangular array of long prismatic battery cells with a pair of TR gas manifolds on outboard sides of the cell stacks and an electric busbar on a centerline of the assembly in accord with aspects of the present disclosure.

FIG. 6 is a plan-view illustration of a representative battery assembly containing a rectangular array of long prismatic battery cells with a TR gas manifold and a pair of electric busbars on a centerline of the assembly and interposed between the cell stacks in accord with aspects of the present disclosure.

FIG. 7 is a plan-view illustration of a representative battery assembly containing a rectangular array of long prismatic battery cells with two TR gas manifolds and two electric busbars on outboard sides of the cell stacks in accord with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this Detailed Description, unless specifically disclaimed: the singular includes the plural and vice versa (e.g., indefinite articles “a” and “an” are to be construed as meaning “one or more” unless expressly disclaimed); the words “and” and “or” shall be both conjunctive and disjunctive; the words “any” and “all” shall both mean “any and all”; and the words “including.” “containing,” “comprising.” “having.” and the like, shall each mean “including without limitation.” Moreover, words of approximation, such as “about.” “almost.” “substantially.” “generally.” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

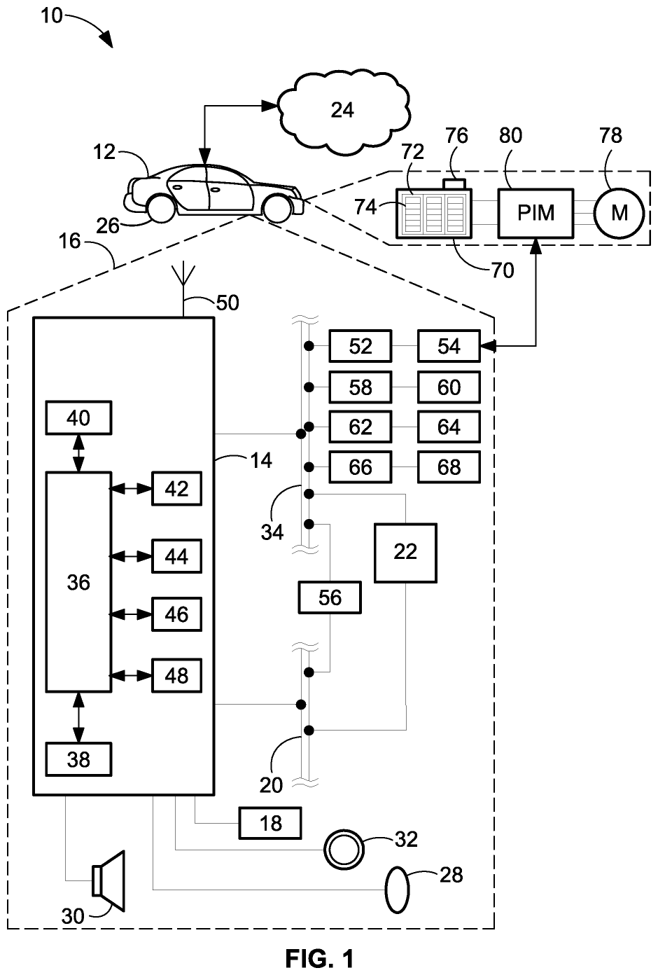

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into an FEV powertrain powered by a single-pack RESS should be appreciated as a non-limiting implementation of disclosed features. As such, it will be understood that aspects and features of this disclosure may be applied to other powertrain and RESS architectures, incorporated into any logically relevant type of motor vehicle, and utilized for both automotive and non-automotive applications alike. Moreover, only select components of the motor vehicles and battery assemblies are shown and described in detail herein. Nevertheless, the vehicles and battery assemblies discussed below may include numerous additional and alternative features, and other available peripheral components, for carrying out the various methods and functions of this disclosure.

The representative vehicle 10 of FIG. 1 is originally equipped with a centerstack telecommunications and information (“telematics”) unit 14 that wirelessly communicates, e.g., via cell towers, satellite service, etc., with a remotely located cloud computing host service 24 (e.g., ONSTAR®). Other in-vehicle hardware components 16 shown in FIG. 1 include, as non-limiting examples, an electronic video display device 18, a microphone 28, audio speakers 30, and assorted user input controls 32 (e.g., buttons, knobs, switches, touchscreens, etc.). These hardware components 16 function as a human/machine interface (HMI) that enables a user to communicate with the telematics unit 14 and other components both resident to and remote from the vehicle 10. Microphone 28, for instance, provides occupants with means to input verbal commands. Conversely, the speakers 30 provide audible output to a vehicle occupant and may be either a stand-alone speaker dedicated for use with the telematics unit 14 or may be part of an audio system 22. The audio system 22 is operatively connected to a network connection interface 34 and an audio bus 20 to receive analog information, rendering it as sound, via one or more speaker components.

Communicatively coupled to the telematics unit 14 is the network connection interface 34, suitable examples of which include twisted pair/fiber optic Ethernet switches, parallel/serial communications buses, local area network (LAN) interfaces, controller area network (CAN) interfaces, and the like. Network connection interface 34 enables vehicle hardware 16 to send and receive signals with one another and with systems and subsystems both onboard and off-board the vehicle body 12. This allows the vehicle 10 to perform assorted vehicle functions, such as modulating powertrain output, activating a vehicle brake system, controlling vehicle steering, regulating charge and discharge of vehicle batteries, and other automated functions. For instance, telematics unit 14 may receive and transmit signals to/from a Powertrain Control Module (PCM) 52, an Onboard Charging Module (OBCM) 54, an Electronic Battery Control Module (EBCM) 56, a Steering Control Module (SCM) 58, a Brake System Control Module (BSCM) 60, and assorted other vehicle ECUs.

With continuing reference to FIG. 1, telematics unit 14 is an onboard computing device that provides a mixture of services, both individually and through its communication with other networked devices. This telematics unit 14 may be generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to an IC real-time clock (RTC) 42 and one or more electronic memory devices 38, each of which may take on the form of a CD-ROM, solid-state drive (SSD) memory, hard-disk drive (HDD) memory, semiconductor memory, etc.

Long-range communication (LRC) capabilities with off-board devices may be provided via a cellular communication component, a navigation and location component (e.g., global positioning system (GPS) transceiver), or a wireless modem, all of which are collectively represented at 44. Short-range communication (SRC) may be provided via a close-range wireless communication device 46 (e.g., a BLUETOOTH® unit), a dedicated short-range communications (DSRC) component 48, and/or a dual antenna 50. It should be understood that the vehicle 10 may be implemented without one or more of the above-listed components or, optionally, may include additional components and functionality as desired for a particular end use. The communications devices described above may provision data exchanges as part of a periodic broadcast in a vehicle-to-vehicle (V2V) communication system or a vehicle-to-everything (V2X) communication system.

CPU 36 receives sensor data from one or more sensing devices that use, for example, photo detection, radar, laser, ultrasonic, optical, infrared, or other suitable technology, including short range communications technologies (e.g., DSRC) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of on-vehicle sensors may be adapted, singly or collectively, to a given vehicle platform for achieving a desired level of autonomous vehicle operation.

To propel the motor vehicle 10, an electrified powertrain is operable to generate and deliver tractive torque to one or more of the vehicle's drive wheels 26. The powertrain is represented in FIG. 1 by an electric traction motor 78 that is connected to a rechargeable energy storage system (RESS), which may be in the nature of a chassis-mounted traction battery pack 70. The battery pack 70 may contain one or more battery modules 72 each housing a group of electrochemical battery cells 74, such as lithium-ion or lithium-polymer battery cells of the pouch, can, or prismatic type. One or more electric machines, such as an adjustable-speed, multiphase motor/generator (M) unit 78, draw electrical power from and, optionally, deliver electrical power to one or more rechargeable battery units, such as traction battery pack 70. An HV electrical system with a power inverter 80 electrically connects the battery pack 70 to the motor/generator unit(s) 78 and modulates the transfer of electrical current therebetween. The battery pack 70 may be configured such that module management, cell sensing, and module-to-host communications functionality is integrated directly into each module 72 and performed wirelessly via a wireless-enabled cell monitoring unit (CMU) 76.

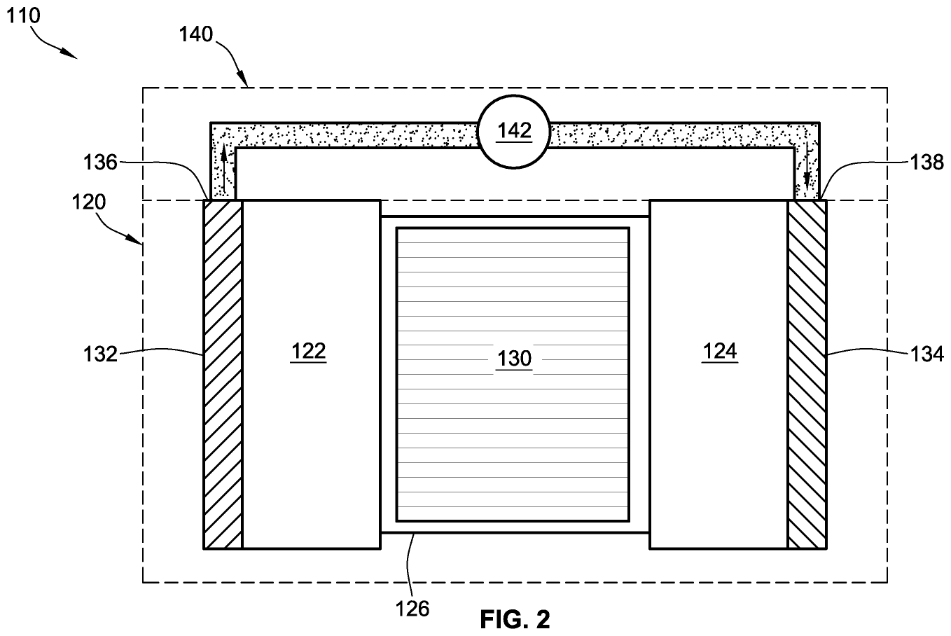

Presented in FIG. 2 is an exemplary electrochemical device in the form of a rechargeable lithium-class battery 110 that powers a desired electrical load, such as motor 78 of FIG. 1. Battery 110 includes a series of electrically conductive electrodes, namely a first (negative or anode) working electrode 122 and a second (positive or cathode) working electrode 124 that are stacked and packaged inside a protective outer housing 120. Reference to either working electrode 122, 124 as an “anode” or “cathode” or, for that matter, as “positive” or “negative” does not limit the electrodes 122, 124 to a particular polarity as the system polarity may change depending on whether the battery 110 is being operated in a charge mode or a discharge mode. In at least some configurations, the cell housing 120 (also referred to therein as cell “can” or “case”) may take on a cylindrical construction, a pouch construction, or a prismatic construction that is formed of aluminum, nickel-plated steel, ABS, PVC, or other suitable material or composite material. The surfaces of a metallic cell case may be coated with a polymeric finish to insulate the metal from internal cell elements and from adjacent cells. Although FIG. 2 illustrates a single galvanic monocell unit enclosed within the cell case 120, it should be appreciated that the housing 120 may store a stack or roll of monocell units (e.g., five to 500 cells or more).

Anode electrode 122 may be fabricated with an active anode electrode material that is capable of incorporating lithium ions during a battery charging operation and releasing lithium ions during a battery discharging operation. For at least some designs, the anode electrode 122 is manufactured, in whole or in part, from a lithium metal, such as lithium-aluminum (LiAl) alloy materials with an Li/Al atomic ratio (as indicated by an atomic percent (at. %) of one type of atom relative to a total number of atoms) in a range from 0 at. %≤Li/Al<70 at. %, and/or aluminum alloys with Al atomic ratio >50 at. % (e.g., lithium metal is smelt). Additional examples of suitable active anode electrode materials include carbonaceous materials (e.g., graphite, hard carbon, soft carbon etc.), silicon, silicon-carbon blended materials (silicon-graphite composite), Li₄Ti₅O₁₂, transition-metals (alloy types, e.g., Sn), metal oxide/sulfides (e.g., SnO₂, FeS and the like), etc.

With continuing reference to FIG. 2, cathode electrode 124 may be fabricated with an active cathode electrode material that is capable of supplying lithium ions during a battery charging operation and incorporating lithium ions during a battery discharging operation. The cathode 124 material may include, for instance, lithium transition metal oxide, phosphate (including olivines), or silicate, such as LiMO₂ (M-Co, Ni, Mn, or combinations thereof); LiM₂O₄ (M=Mn, Ti, or combinations thereof), LiMPO₄ (M=Fe, Mn, Co, or combinations thereof), and LiMxM′2-xO4 (M, M′=Mn or Ni). Additional non-limiting examples of suitable active cathode electrode materials include lithium nickel cobalt manganese oxide (NCM), lithium nickel cobalt aluminum oxide (NCA), lithium nickel cobalt manganese aluminum oxide (NCMA), and other lithium transition-metal oxides.

Disposed inside the battery cell case 120 of FIG. 2 and sandwiched between each mated pair of working electrodes 122, 124 is an electrically isolating porous separator 126. The porous separator 126 may be in the nature of an electrically non-conductive, ion-transporting microporous or nanoporous polymeric separator sheet. Separator 126 may be a sheet-like structure that is composed of a porous polyolefin membrane, e.g., with a porosity of about 35% to about 65% and a thickness of approximately 10-30 microns. Electrically non-conductive ceramic particles (e.g., silica) may be coated onto the porous membrane surfaces of the separators 126. The porous separator 126 may incorporate a non-aqueous fluid electrolyte composition, a solid electrolyte composition, and/or a quasi-solid electrolyte composition, collectively designated 130, which may also be present in the negative electrode 122 and the positive electrode 124.

A negative electrode current collector 132 of the electrochemical battery cell 110 may be positioned on or near the negative electrode 122, and a positive electrode current collector 134 may be positioned on or near the positive electrode 124. The negative electrode current collector 132 and positive electrode current collector 134 respectively collect and move free electrons to and from an external circuit 140. An interruptible external circuit 140 with a load 142 connects to the negative electrode 122, through its respective current collector 132 and electrode tab 136, and to the positive electrode 124, through its respective current collector 134 and electrode tab 138.

The porous separator 126 may operate as both an electrical insulator and a mechanical support structure by being sandwiched between the two electrodes 122, 124 to prevent the electrodes from physically contacting each other and, thus, the occurrence of a short circuit. In addition to providing a physical barrier between the electrodes 122, 124, the separator 126 may provide a minimal resistance path for internal passage of lithium ions (and related anions) during cycling of the lithium ions to facilitate functioning of the battery 110. For some configurations, the porous separator 126 may be a microporous polymeric separator including a polyolefin. The polyolefin may be a homopolymer, which is derived from a single monomer constituent, or a heteropolymer, which is derived from more than one monomer constituent, and may be either linear or branched. In a solid-state battery, the role of the separator may be partially/fully provided by a solid electrolyte layer.

Operating as a rechargeable energy storage device, the battery cell 110 generates electric current that is transmitted to one or more electric loads 142 operatively connected to the external circuit 140. While the load 142 may be any number of electric devices, a few non-limiting examples of power-consuming and power-generating devices include electric traction motors for hybrid-electric and full-electric vehicles, photovoltaic cell arrays, standalone power stations and portable power packs, server systems, wind turbine farms, etc. The battery cell 110 may include a variety of other components that, while not depicted herein for simplicity and brevity, are nonetheless readily available. For instance, the battery 110 may include one or more gaskets, terminal caps, tabs, battery terminals, cooling hardware, charging hardware, and other commercially available components or materials that may be situated on or in the battery 110. Moreover, the size and shape and operating characteristics of the battery 110 may vary depending on the particular application for which it is designed.

To help increase volumetric efficiency and improve cell cooling, discussed below are prismatic battery assemblies that contain long prismatic cells with interleaved gas manifolds and electric busbars. By way of non-limiting example, a set number of long prismatic battery cells (e.g., 40+) is stacked face-to-face with the resultant stacks arranged in mutually parallel fore-aft rows of prismatic cells with the length of the cells (i.e., major dimension of major face) placed in a cross-car direction inside of a battery pack housing. Each long cell case may be made as a three-piece construction—can, insulation plate, and header—with openings on one or both of the case's minor faces (e.g., in the fore-aft width direction). These long prismatic cells have electrical terminals on one lateral side (i.e., extending through one minor face) and a TR gas vent on the opposite lateral side (i.e., extending through the opposite minor face). The increased length of the prismatic cells offers a concomitant increase in cell capacity and power output.

Unlike conventional prismatic battery packs, cell venting and bussing are located on the sides of the cell stacks rather than the tops and/or bottoms of the cells. A shared vent manifold may extend along the pack's centerline, between the rows of cells, and the bussing rails may be located on the RESS halo side of the pack, laterally outboard of the cells. A single gas manifold may be shared by all cells in a given row or all cells in neighboring rows. With the foregoing arrangement, cell venting and bussing does not consume vertical (Z) space in the pack. As another option, vent manifolds may be located on both outboard sides of the cells with the bussing rails extending fore-aft along the pack center. With this arrangement, the battery pack assembly has a reduced vertical (Z) height with better protection of the busbars from side intrusion. Passive cooling of the prismatic battery cells may be increased by sandwiching the cells between two cold plates. This may enable the use of low-cost steel, rather than aluminum, for manufacturing the prismatic shell case; steel cell cases cooled from two sides remain cooler during battery charge and discharge cycles than aluminum cell cases cooled from one side.

There are many potential benefits for using the foregoing prismatic battery assembly features over conventional solutions. For instance, a prismatic battery pack using long cells may reduce a total number of cells (e.g., 110+ cell reduction per pack) while maintaining the same pack storage capacity and power rating. Using long prismatic cells versus conventional cell form factors may also increase the pack's volumetric efficiency (e.g., 12 mm Z-height reduction resulting in 12% volumetric efficiency improvement). By using multiple cold plates, rather than a single cold plate, disclosed prismatic battery assembly architectures may improve thermal management of the battery pack (e.g., decrease cell operating temperatures by at least about 6 to 7 degrees Celsius (C°)).

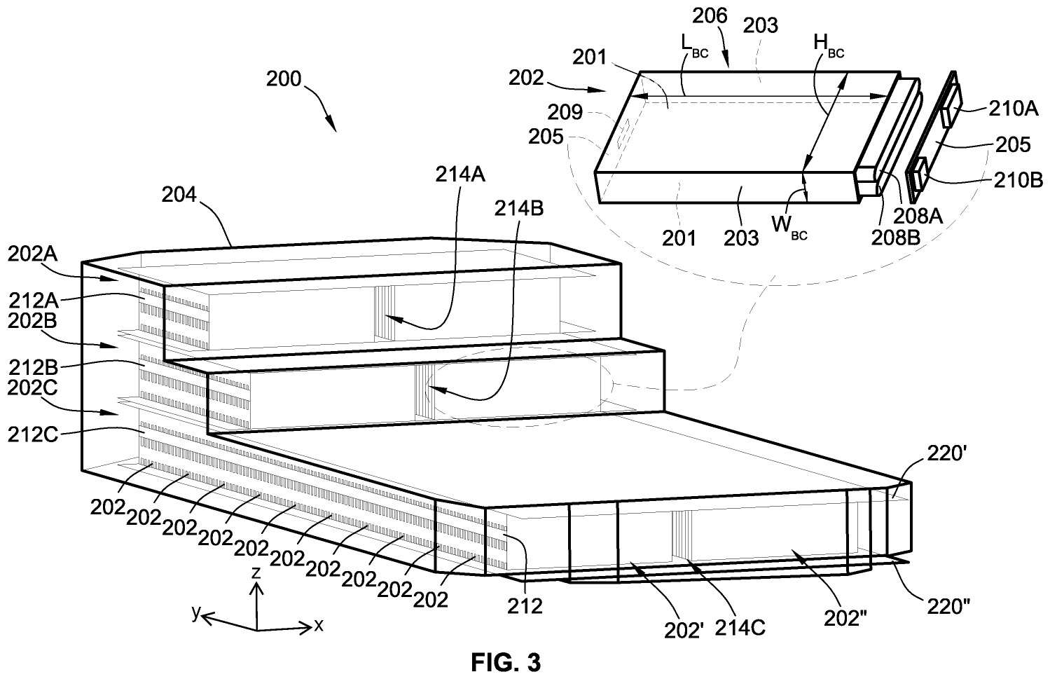

Turning next to FIG. 3 there is shown a segment of a rechargeable energy storage system (RESS) in the form of a traction battery pack (or “battery assembly”) 200 that is adapted for storing and supplying high-voltage electrical energy used, for example, to propel an electric-drive vehicle, such as the all-electric automobile 10 of FIG. 1. This battery pack 200 may be representative of a deep-cycle, high-ampere capacity vehicle battery system rated for approximately 400 to 1400 VDC or more, for example, depending on a desired vehicle range, gross vehicle weight, and power ratings of the various accessory loads drawing electrical power from the RESS. To this end, the battery pack 200 may be electrically connectable to an electrical load or an electrical source, or both, such as polyphase permanent magnet (PM) motor or a field-wound separately excited motor (SEM) or other form of electric traction motor (M) 78. The traction battery pack 200 incorporates an aggregation (e.g., 100's or 1000's) of discrete electrochemical cells connected in series and/or parallel to achieve the desired total voltage and total current requirements. Although differing in appearance, it is envisioned that any of the features and options described above with reference to the traction battery pack 70 of FIG. 1 and the rechargeable lithium-class battery 110 of FIG. 2 may be incorporated, singly or in any combination, into the various battery assembly configurations of FIGS. 3-7, and vice versa.

The traction battery pack 200 of FIG. 3 is generally typified by an assemblage of electrochemical battery cells that is housed inside a protective battery container. In the illustrated example, lithium-class prismatic battery cells 202 are arranged in several rectangular arrays of cells 202A, 202B and 202C that are stacked one on top of the other (e.g., in three levels in FIG. 3) and securely stored inside a rigid battery pack housing 204. The pack housing 204 may be constructed of a metallic, polymeric, or fiber-reinforced polymer (FRP) material, including combinations thereof, to satisfy various mechanical, manufacturing, and thermal design specifications. The battery housing 204 may have an electrically insulated and lightweight construction, as shown, and may be constructed in a myriad of regular and irregular geometric configurations for accommodating application-specific packaging parameters. Likewise, the battery assembly 200 may be embodied as a multi-level traction battery pack with multiple rectangular arrays of lithium-ion prismatic cells that share a common housing, as shown, or may take on alternative battery assembly configurations (e.g., single-level pack or cells packaged within individual battery modules), may employ other suitable battery technologies (e.g., solid-state battery), and may utilize other cell arrangements (e.g., three or more cell rows per pack layer).

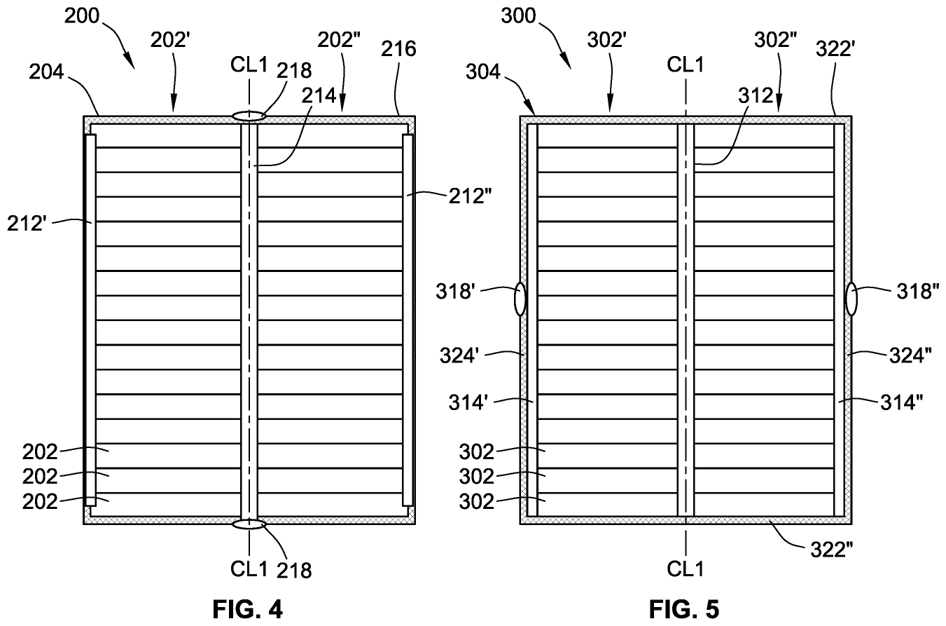

With continuing reference to FIG. 3, the prismatic battery cells 202 are arranged face-to-face in multiple cell stacks—e.g., first and second rectilinear cell stacks 202′ and 202″—that are located inside of and extend longitudinally across the pack housing 204 (also referred to herein as “assembly housing”). As shown, the two cell stacks 202′, 202″ are arranged substantially parallel to each other (e.g., stacks extend horizontally in the Y-direction) and to a pack centerline CL1 (FIG. 4) that extends longitudinally through a central plane of the pack housing 204, e.g., in a fore-aft direction relative to a vehicle body. With this arrangement, a largest (major) dimension of an edge of the largest (major) faces 201 of the prismatic battery cells 202, namely each cell's length L_{BC}, are horizontal and substantially orthogonal to the longitudinal centerline CL1 of the pack housing 204 (e.g., cell lengths extend horizontally in the X-direction). At the same time, a major dimension of an edge of the smallest (minor) faces 205 of the prismatic battery cells 202, namely each cell's height H_{BC}, are vertical and substantially orthogonal to the pack centerline CL1 (e.g., cell heights extend vertically in the Z-direction), whereas the minor dimension of an edge of the medium-side (medial) faces 203 of the prismatic battery cells 202, namely each cell's width WBC, are horizontal and substantially parallel to the pack centerline CL1.

As the name suggests, each prismatic battery cell 202 may be typified by a prism-shaped cell can 206 that houses therein one or more electrochemical cells, such as first and second “jellyroll” cells 208A and 208B. In accord with the illustrated example, each of the cell cans 206 may have a right rectangular-prism shape that—by geometric definition—is composed of two parallel and opposing rectangular major faces 201, two parallel and opposing rectangular medial faces 203, and two parallel and opposing rectangular minor faces 203. The medial faces 203 are both smaller than, substantially orthogonal to, and adjoin both major faces 201, and the minor faces 205 are both smaller than, substantially orthogonal to, and adjoin both major faces 201 and both medial faces 203. The adjoining edges of the cell can 206 at which the faces 201, 203 and 205 border one another may be squared (as shown), chamfered, filleted, etc., and still be considered a “prism” within the scope of this disclosure. It should be appreciated that each battery cell 202 may contain greater or fewer than the two cells 208A and 208B, which may take on “jellyroll” designs (as shown), “layer cake” designs, or any other suitable form factor that contains any desired number of galvanic monocells.

The battery assembly architectures of FIGS. 3-7 use long prismatic cells that are interleaved with gas manifolds and electric busbars to provide increased volumetric efficiency and reduced TR gas manifold sizes. The prismatic battery cells 202 may be considered “long” in that a mathematical ratio of the cells' cross-car length L_{BC} to the cells' vertical height H_{BC} is at least about 2:1 or, in some designs, at least about 2.5:1 or, in some desired solutions, approximately 3.1:1. To this end, a mathematical ratio of the cells' fore-aft width WBC to the cells' cross-car length L_{BC} may be at least about 3:1 or, in some designs, at least about 4:1 or, in some desired solutions, approximately 5.2:1. For at least some applications, the rectangular prism-shaped cans are tripartite polyhedral constructions that, when assembled, are typified by eight vertices, twelve edges, and six rectangular faces in which each pair of opposite faces is congruent, and wherein the length of each prism-shaped can is at least about 400 to 500 millimeters (mm).

Unlike most conventional prismatic battery pack designs, in which cell venting and bussing is packaged on top or on bottom of the cells, the battery assembly solutions presented in FIG. 3-7 interleave the cell venting and bussing with the fore-aft rows of prismatic cells. By way of example, and not limitation, each prismatic cell 202 has a cell vent (shown hidden at 209 in the inset view of FIG. 3), through which cell-borne gases are evacuated from the cell can 206, and a pair of (positive and negative) electrical terminals 210A and 210B, by which the internal cells 208A and 208B are electrically interconnected with the in-pack bussing rails 212A, 212B and 212C and other cells 202 within the pack 200. According to the inset view of FIG. 3, the cell vent 209 is located on and extends through one lateral (left-side or first) minor face 205 of the cell can 206, whereas the electrical terminals 210A. 210B are located on and extend through the opposite lateral (right-side or second) minor face 205 of the cell can 206. While illustrated in the inset view with the vent 209 on the left-hand side of the can 206 and the terminals 210A, 210B on the right-hand side of the can 206, it will be appreciated that the relative locations of the vents 209 and terminals 210A, 210B may be modified to accommodate the packaging locations of the venting manifolds and bussing rails.

With collective reference to FIGS. 3 and 4, an electric-power distributing busbar is located outboard of each prismatic cell stack and electrically coupled to the cell terminals of each prismatic cell in that stack. The multi-level battery assembly 200 of FIG. 3, for example, contains six busbars-six sets of positive and negative busbar rails-only three of which are visible at 212A-212C (collectively designated as busbar 212). Each busbar rail set 212A-212C electrically connects to the prismatic cells 202 in a respective one of the cell stacks 202′, 202″ in a respective level 202A-202C of the pack 200. To this end, the battery assembly 200 is shown in FIG. 4 with a pair of (left and right) electrically conductive busbars 212′ and 212″ (collectively 212) that electrically couple to the terminals 210A, 210B of the prismatic cells 202 in the pair of (left and right) cell stacks 202′, 202″, respectively. The busbars 212 of FIGS. 3 and 4 are rigidly mounted inside the assembly housing 204, located laterally outboard of the cell stacks 202′, 202″ and interposed between the prismatic cells 202 and the lateral sidewalls of the housing 204. To accommodate this packaging layout, the electrical terminals 210A, 210B of the prismatic battery cells 202 face outboard (i.e., away from the pack centerline CL1) and towards the interior surfaces of the assembly 204 sidewalls, which may structurally support thereon the busbars 212′, 212″. With this arrangement, the busbars 212 are substantially parallel to each other and to the cell stacks 202′, 202″, laterally spaced from and substantially parallel to the pack centerline CL1.

Battery assembly 200 of FIGS. 3 and 4 also contains multiple shared TR gas manifolds that are interposed between the cell stacks and fluidly coupled to the prismatic cell vents in the stacks to evacuate cell-borne gases from the pack's housing. The multi-level battery assembly 200 of FIG. 3, for example, contains three gas manifolds 214A, 214B and 214C (collectively designated as manifold 214), one for each level 202A-202C in the pack 200. To this end, the battery assembly 200 is shown in FIG. 4 with a shared gas manifold 214, which is located inside the assembly housing 204 and sandwiched between the two cell stacks 202′, 202″. Each shared vent manifold 214 may extend along the pack's centerline, confined between the cell rows 202′ 202″, and fluidly connect to all of the cell vents 209 in those rows to receive therefrom cell-generated gases and evacuate the received gases from the pack housing 204. The vent manifolds 214 may be configured as elongated, rectilinear channels, as shown in FIG. 3, or may each be configured as an elongated, rectilinear pipe or sleeve with multiple intake ports, as shown in FIG. 4. A pair of housing vents 218 (FIG. 4) fluidly connect to the gas manifold 214 to receive therefrom gases generated by the prismatic battery cells 202 and evacuate the manifold gasses from the assembly housing 204. To accommodate this packaging layout, the cell vents 209 of the prismatic battery cells 202 face inboard (i.e., towards the pack centerline CL1) and towards the vents 209 of the neighboring cells 202. With this arrangement, the manifolds 214 are substantially parallel to each other and to the cell stacks 202′, 202″, extending along and substantially parallel to the pack centerline CL1.

To improve thermal management of the battery assembly 200, the pack housing 204 may integrate thereto a passive thermal management (PTM) system that utilizes, among other things, thermally conductive cold plates for removing thermal energy from multiple faces of the prismatic battery cells. In accord with the illustrated example of FIG. 3, the pack housing 204 contains six high-strength steel or aluminum cold plates (two of which are designated 220′ and 220″), one pair of plates for each level 202A-202C of the pack 200. A top (first) cold plate 220′ extends across, abuts, and passively extracts thermal energy from the topsides of the prismatic battery cells 202 in the neighboring cell stacks 202′, 202″. At the same time, a bottom (second) cold plate 220″ extends across, abuts, and passively extracts thermal energy from the bottom sides of the prismatic battery cells 202 in the neighboring cell stacks 202′, 202″. With this arrangement, the cold plates 220′, 220″ are vertically spaced from and substantially parallel to each other, extending transversely across the pack housing 204 and sandwiching therebetween the stacks 202′, 202″ of battery cells 202. With the disclosed features, it is also possible for adjacent levels to share a cold plate (e.g., the battery assembly 200 may contain a total of four cold plates 220′, 220″ with a single plate interposed between and shared by levels 1 and 2 and a single plate interposed between and shared by levels 2 and 3).

As noted above, FIG. 4 is a plan-view illustration of a portion of the prismatic battery assembly 200 showing one of the rectangular arrays of long battery cells 202 interleaved with a shared gas manifold 214 and two electric busbars 212. FIG. 4 also shows the manifold 214 located between the cell stacks 202′, 202″, extending along the housing centerline CL1, and the busbars 212 located on laterally outboard sides of the prismatic battery cells 202, spaced transversely from the manifold 214. This pack design helps to reduce packaging space by employing a common vent manifold that is shared by at least two cell stacks while also integrating the bussing rails into the interior surfaces of the pack sidewalls. A thermal barrier, such as a mica sheet, may be secured between the cells in the cross-car direction, e.g., to help prevent thermal runaway propagation (TRP) by blocking hot TR gases from traveling from one stack to the other. As another option, one or more segments of the gas manifold 214 may be covered by a manifold lining that is formed with a high-temperature material, such as steel or mica, that will allow TR gases to exhaust from the pack housing 204 through the manifold 214 without affecting the other cells.

Turning next to FIG. 5, there is shown another representative prismatic battery assembly 300 that contains a rectangular array of long prismatic cells 302 that are arranged in rectilinear cell stacks 302′ and 302″, which are interleaved with a pair of TR gas manifolds 314′ and 314″ and a central electric busbar 312. With the exception of those differences identified below, the battery assemblies 300, 400 and 500 of FIGS. 5, 6 and 7, respectively, may be structurally identical to and/or may include any of the options and features described above with respect to the battery assembly 200 of FIGS. 3 and 4. As a non-limiting point of demarcation, the battery assembly 300 of FIG. 5 may employ a single busbar 312 and multiple manifolds 314′ and 314″ for the neighboring pair of busbars 302. To this end, the gas manifolds 314′ and 314″ are shown on laterally outboard sides of the cell stacks 302′, 302″, substantially parallel to and spaced transversely from the pack centerline CL1, whereas the busbar 312 extends along the pack centerline CL1, substantially parallel to the manifolds 314′, 314″ and the cell stacks 302′, 302″. The busbar 312 is sandwiched between and shared by the two cell stacks 302′, 302″, whereas each gas manifold 314′, 314″ is located on a respective lateral side of and used by a respective one of the cell stacks 302′, 302″. Located on each lateral side of the pack housing 304 is a respective housing vent 318′ and 318″ that fluidly connects to a respective one of the gas manifolds 314′, 314″ to receive and evacuate cell-borne gasses from the housing 304.

One or more of the TR gas manifolds 314′, 314″ of the battery assembly 300 of FIG. 5 may be integrated into the internal structure of the pack housing 304 to achieve additional space savings with a concomitant improvement in volumetric efficiency. For at least some applications, the assembly housing 304 may include a rigid, load-bearing “halo” frame that surrounds and protects the prismatic battery cells 302. The halo frame is represented in FIG. 5 by a pair of opposing and elongated (fore and aft) end tubes 322′ and 322″ that are interconnected with a pair of opposing and elongated (port-side and starboard-side) side tubes 324′ and 324″. In this instance, the port-side gas manifold 314′ extends into and through the halo's port-side tube 324′, evacuating gases through the port-side housing vent 318′. The starboard-side gas manifold 314″ extends into and through the halo's starboard-side tube 324″, evacuating gases through the starboard-side housing vent 318″. It should be appreciated that the shape, size, and composition of the halo frame may be modified for any desired application of the battery assembly.

By locating the gas manifolds 314′, 314″ within the lateral halo tubes 324′, 324″, the prismatic battery assembly 300 may evacuate hot TR gases from the pack housing 304 without the gases contacting neighboring cells 302 within the same stack or within the neighboring stack. Optionally, an intrusion volume of the pack housing 304 may also serve as a TR gas vent channel. Placing the electrical busbar 312 rails at the center of the pack housing 304, between the cell stacks 302′, 302″, may achieve better protection for the bussing structures (e.g., protects the bussing rails from a side-impact collision event). Placing the manifolds 314′, 314″ within the halo frame may also help to separate the cell venting from the cell terminals and bussing rails. In so doing, there is limited access for the vent gases to cause arcing in the event one or more of the prismatic battery cells enters into thermal runaway. For at least the foregoing reasons, the battery assembly 300 of FIG. 5 may be the most ideal design option offering the most volumetric efficiency, the best bussing rail protection, reduced bussing rail costs and materials, and best prevention of TRP and gas-induced electrical arcing.

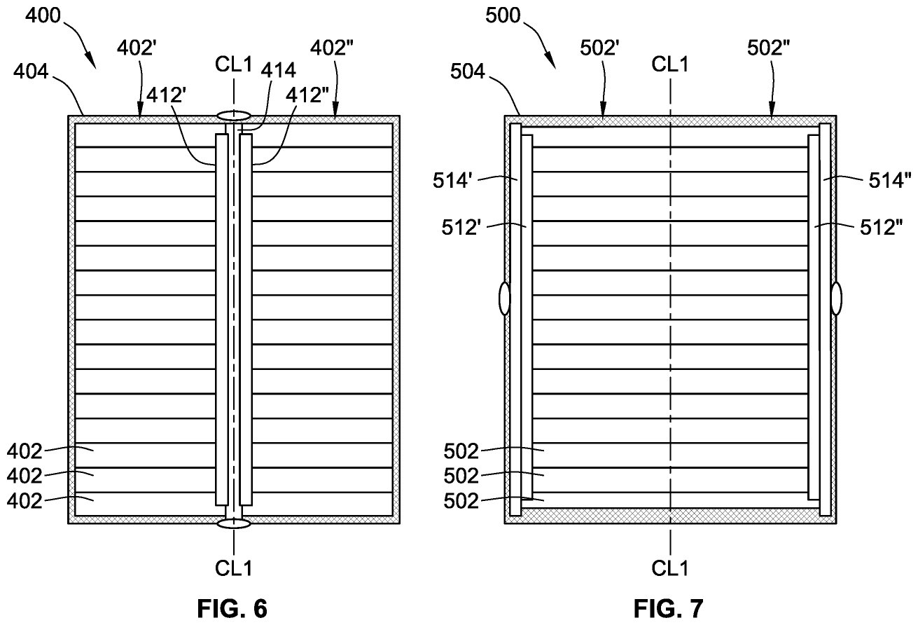

FIG. 6 illustrates another representative prismatic battery assembly 400 that contains a rectangular array of long prismatic cells 402 that are arranged in rectilinear cell stacks 402′ and 402″, which are interleaved with a pair of electric busbars 412′ and 412″ and a single gas manifold 414. For this design option, the electrical busbars 412′, 412″ and the gas manifold 414 are all located between the neighboring cell stacks 402′, 402″, extending along or immediately adjacent the longitudinal centerline CL1 of the assembly housing 404. There are immediate gains in volumetric efficiency and space savings by packaging both the cell venting and cell bussing in the same space between the rows of battery cells 402. It may be desirable to insert a thermal and electrical barrier, such as a vertically oriented mica sheet, between the cell stacks 402′, 402″ to help prevent arcing and TRP. As a further option, a mica sheet and/or an ICB board (not shown) may be used to cover the bussing. The vent gases may also be enclosed in a channel sleeve or manifold liners. It is envisioned that the two electrical busbars 412′, 412″ of FIG. 6 may be replaced by a single busbar that is shared by the neighboring cell stacks 402′, 402″.

FIG. 7 is a plan-view illustration of an example of a prismatic battery assembly 500 that contains a rectangular array of long prismatic cells 502 that are arranged in neighboring rectilinear cell stacks 502′ and 502″. These cell stacks 502′ and 502″ are interleaved with a pair of electric busbars 512′ and 512″ and a pair of TR gas manifolds 514′ and 514″, all of which are located on laterally outboard sides of the cell stacks 502′, 502″. For instance, a port-side (first) electrical busbar 512′ is located on one (port or first) lateral side of the pack housing 504, and a starboard-side (second) electrical busbar 512″ is located on the opposite (starboard or second) lateral side of the pack housing 504. In the same vein, a port-side (first) gas manifold 514′ is located on one (port or first) lateral side of the pack housing 504, and a starboard-side (second) gas manifold 514′ is located on the opposite (starboard or second) lateral side of the pack housing 504. With this arrangement, the busbars 512′, 512″ and manifolds 514′, 514″ are substantially parallel to each other and to the rectilinear cell stacks 502′ and 502″, spaced transversely from the pack centerline CL1. This design may enable an increase in the lengths of the prismatic battery cells 502 by packaging the cell bussing rails 512′, 512″ and the cell venting manifolds 514′, 514″ on or in the halo frame sides of the assembly 500. By feeding the cell vents into shared manifolds that are routed through the halo frame rails, hot TR gases cannot impinge upon adjacent battery cells. It is also envisioned that the intrusion volume of the pack housing can also serve as a TR gas vent channel. As noted above, any of the herein described battery assemblies may include greater than two rows of long prismatic cells, which may be packaged inside a single-level pack or a multi-level pack.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A prismatic battery assembly, comprising:
an assembly housing;
a plurality of prismatic battery cells arranged in first and second cell stacks located inside of and extending longitudinally across the assembly housing, each of the prismatic battery cells including a prism-shaped cell can containing an electrochemical cell, the cell can having a cell vent and a pair of electrical terminals located at first and/or second lateral ends of the cell can;
an electrical busbar electrically connected to the electrical terminals of the prismatic battery cells and located inside the assembly housing between the first and second cell stacks or laterally outboard of the first and second cell stacks; and
a gas manifold fluidly connected to the cell vents of the prismatic battery cells and located inside the assembly housing between the first and second cell stacks or laterally outboard of the first and second cell stacks.

2. The prismatic battery assembly of claim 1, wherein the first and second cell stacks are arranged substantially parallel to each other, and wherein the electrical busbar and the gas manifold are substantially parallel to each other and the first and second cell stacks.

3. The prismatic battery assembly of claim 1, wherein each of the cell cans has a rectangular-prism shape with two opposing major faces, two opposing medial faces substantially orthogonal to and adjoining the two major faces, and two opposing minor faces substantially orthogonal to and adjoining the two medial faces, and wherein a ratio of a length to a height of the major faces is at least about 2.5:1.

4. The prismatic battery assembly of claim 3, wherein a ratio of a width of the minor faces to the length of the major faces is at least about 4:1.

5. The prismatic battery assembly of claim 3, wherein the major faces of the cell cans are substantially orthogonal to a longitudinal centerline of the assembly housing.

6. The prismatic battery assembly of claim 3, wherein the minor faces include a first minor face at the first end of the cell can and a second minor face located at the second end of the cell can, and wherein the cell vent extends through the first minor face of the cell can and the electrical terminals are located on the second minor face of the cell can.

7. The prismatic battery assembly of claim 6, wherein the gas manifold is located between the first and second cell stacks and extends along a longitudinal centerline of the assembly housing, and wherein the electric busbar includes first and second electrical busbars located on first and second lateral sides, respectively, of the first and second cell stacks.

8. The prismatic battery assembly of claim 6, wherein the electrical busbar is located between the first and second cell stacks and extends along a longitudinal centerline of the assembly housing, and wherein the gas manifold includes first and second gas manifolds located on first and second lateral sides, respectively, of the first and second cell stacks.

9. The prismatic battery assembly of claim 6, wherein the electrical busbar and the gas manifold are located between the first and second cell stacks and extend along a longitudinal centerline of the assembly housing.

10. The prismatic battery assembly of claim 6, wherein the electrical busbar includes first and second electrical busbars located on first and second lateral sides, respectively, of the first and second cell stacks, and wherein the gas manifold includes first and second gas manifolds located on the first and second lateral sides, respectively, of the first and second cell stacks.

11. The prismatic battery assembly of claim 1, wherein the assembly housing includes a rigid frame with first and second tubes adjacent first and second lateral sides, respectively, of the first and second cell stacks, and wherein the gas manifold includes first and second gas manifolds each extending into and through the first and second rigid tubes, respectively.

12. The prismatic battery assembly of claim 1, further comprising:
a top cold plate extending across and configured to extract thermal energy from a topside of the first and second cell stacks; and
a bottom cold plate extending across and configured to extract thermal energy from a bottom side of the first and second cell stacks.

13. The prismatic battery assembly of claim 1, wherein the assembly housing includes a pair of housing vents fluidly connected to the gas manifold and configured to evacuate gases generated by the prismatic battery cells from the assembly housing.

14. A motor vehicle comprising:
a vehicle body;
a plurality of road wheels attached to the vehicle body;
a traction motor attached to the vehicle body and operable to drive one or more of the road wheels to thereby propel the motor vehicle; and
a traction battery pack electrically connected to and operable to power the traction motor, the traction battery pack including:
a pack housing attached to the vehicle body;
a rectangular array of prismatic battery cells arranged in first and second cell stacks located inside of and extending longitudinally across the pack housing, each of the prismatic battery cells including a rectangular prism-shaped cell can containing an electrochemical cell, the cell can having a cell vent and a pair of electrical terminals located at first and/or second lateral ends of the cell can, wherein a ratio of a length to a height of opposing major faces of the rectangular prism-shaped cell cans is at least about 2.5:1;
an electrical busbar electrically connected to the electrical terminals of the prismatic battery cells and located inside the pack housing between the first and second cell stacks or laterally outboard of the first and second cell stacks; and
a gas manifold fluidly connected to the cell vents of the prismatic battery cells and located inside the pack housing between the first and second cell stacks or laterally outboard of the first and second cell stacks.

15. A method of constructing a prismatic battery assembly, the method comprising:
receiving an assembly housing of the prismatic battery assembly;
arranging a plurality of prismatic battery cells in first and second cell stacks;
locating the first and second cell stacks inside of and extending longitudinally across the assembly housing, each of the prismatic battery cells including a prism-shaped cell can containing an electrochemical cell, the cell can having a cell vent and a pair of electrical terminals located at first and/or second lateral ends of the cell can;
locating an electrical busbar inside the assembly housing between the first and second cell stacks or laterally outboard of the first and second cell stacks;
electrically connecting the electrical busbar to the electrical terminals of the prismatic battery cells;
locating a gas manifold inside the assembly housing between the first and second cell stacks or laterally outboard of the first and second cell stacks; and
fluidly connecting the gas manifold to the cell vents of the prismatic battery cells.

16. The method of claim 15, wherein locating the first and second cell stacks inside of the assembly housing includes arranging the first and second cell stacks substantially parallel to each other, and wherein locating the electrical busbar and the gas manifold inside the assembly housing includes arranging the electrical busbar and the gas manifold substantially parallel to each other and to the first and second cell stacks.

17. The method of claim 15, wherein each of the cell cans has a rectangular-prism shape with two opposing major faces, two opposing medial faces substantially orthogonal to and adjoining the two major faces, and two opposing minor faces substantially orthogonal to and adjoining the two medial faces, and wherein a ratio of a length to a height of the major faces is at least about 2.5:1.

18. The method of claim 17, wherein the major faces of the cell cans are substantially orthogonal to a longitudinal centerline of the assembly housing.

19. The method of claim 18, wherein the minor faces include a first minor face at the first end of the cell can and a second minor face located at the second end of the cell can, and wherein the cell vent extends through the first minor face of the cell can and the electrical terminals are located on the second minor face of the cell can.

20. The method of claim 15, further comprising:
locating a top cold plate inside the assembly housing and extending across top medial faces of the prismatic battery cells, the top cold plate being configured to extract thermal energy from a topside of the first and second cell stacks; and
locating a bottom cold plate inside the assembly housing and extending across bottom medial faces of the prismatic battery cells, the bottom cold plate being configured to extract thermal energy from a bottom side of the first and second cell stacks.
